(19) United States
(12) Patent Application Publication
(10) Pub. No.: US 2026/0180781 A1
(43) Pub. Date: Jun. 25, 2026

(54) SERVER DEVICE FOR PROCESSING DATA AND METHODS THEREOF

(71) Applicant: CRYPTO LAB INC., Seoul (KR)

(72) Inventors: Alain Passelegue, Seoul (KR); Duc Tu Pham, Seoul (KR); Jaejin Lee, Suwon-si (KR); Jaehyung Kim, Stanford, CA (US); Guillaume Hanrot, Seoul (KR); Damien Stehle, Seoul (KR)

(21) Appl. No.: 19/220,608

(22) Filed: May 28, 2025

(30) Foreign Application Priority Data
May 28, 2024 (KR) 10-2024-0069160
Jul. 9, 2024 (KR) 10-2024-0090122
Jul. 31, 2024 (KR) 10-2024-0101510
Jan. 9, 2025 (KR) 10-2025-0003678
May 22, 2025 (KR) 10-2025-0067012

(51) Int. Cl. H04L 9/00; H04L 9/32

(52) U.S. Cl. CPC H04L 9/008; H04L 9/3236

(57) ABSTRACT

Disclosed is a server device. The device includes: a communication interface configured to communicate with an external device; a memory storing a plurality of reference data; and a processor. Here, the processor is configured to obtain an inner product operation result based on the plurality of reference data and a homomorphic ciphertext if the homomorphic ciphertext generated using a coefficient encoding method is received from the external device through the communication interface, and transmit at least one of private information retrieval (PIR) result data, private membership test (PMT) result data, or private set intersection (PSI) result data, obtained based on the inner product operation result, to the external device through the communication interface.

### TECHNICAL FIELD

The present disclosure relates to a server device for processing a homomorphic ciphertext and a data processing method thereof.

### BACKGROUND ART

As electronic technology advances, various types of electronic devices have been developed. An electronic device may provide various services in linkage with an external device such as a server device.

The server device may store various user information and provide various services based on each user request.

In case of using a service linked to the server device, user convenience may be greatly increased. However, personal information of a user may be leaked through the server device. For example, if the user wants to use a specific service by transmitting a user face photo to the server device, there is a possibility that the user face photo may be leaked during a process of transmitting the user face photo to the server device or may be leaked on the server device.

Accordingly, a need for a technology capable of collaborating linking to the external device while maintaining security for various personal information has arisen.

### DISCLOSURE OF INVENTION

### Solution to Problem

The present disclosure provides a server device capable of providing various services while maintaining security by performing an operation on homomorphically encrypted data, and a data processing method thereof.

According to an embodiment of the present disclosure, provided is a server device including: a communication interface configured to communicate with an external device; a memory storing a plurality of reference data; and a processor, wherein the processor is configured to obtain an inner product operation result based on the plurality of reference data and a homomorphic ciphertext if the homomorphic ciphertext generated using a coefficient encoding method is received from the external device through the communication interface, and transmit at least one of private information retrieval (PIR) result data, private membership test (PMT) result data, or private set intersection (PSI) result data, obtained based on the inner product operation result, to the external device through the communication interface.

The processor may be configured to obtain target data having a length corresponding to that of the homomorphic ciphertext by combining the plurality of reference data, perform a multiplication operation between the homomorphic ciphertext and the target data, and obtain the inner product operation result from a multiplication operation result by using a module learning with errors (MLWE) extraction method.

The homomorphic ciphertext received from the external device may be a vector ciphertext in which messages are densely packed into a former half of the homomorphic ciphertext.

The processor may be configured to generate the plurality of homomorphic ciphertexts by performing a plurality of automorphism transformations on the homomorphic ciphertext if the homomorphic ciphertext generated using the coefficient encoding method is received from the external device through the communication interface, and obtain the inner product operation result by respectively multiplying a plurality of target data, which are obtained by combining data at corresponding positions in the plurality of reference data, by the plurality of homomorphic ciphertexts, and then summing a plurality of multiplication results.

The homomorphic ciphertext received from the external device may be a vector ciphertext in which messages are packed to be distributed at each predetermined distance.

The homomorphic ciphertext may be a homomorphic ciphertext for hash data that is generated using the coefficient encoding method, the PIR result data may be a homomorphic ciphertext including data matching the hash data in the plurality of reference data, and the PMT result data may be a homomorphic ciphertext indicating whether the data matching the hash data is included in the plurality of reference data.

The processor may be configured to transform the inner product operation result into a homomorphic ciphertext including 0 or 1 by substituting the inner product operation result into an approximation polynomial for approximating data to 0 in a section where a probability that the data included in an inner product operation result value is not 1 is higher than a predetermined threshold probability, obtain the PIR result data by multiplying the transformed homomorphic ciphertext by each of the plurality of reference data, and obtain the PMT result data by summing respective elements of the transformed homomorphic ciphertext.

According to an embodiment of the present disclosure, provided is a data processing method of a server device, the method including: obtaining an inner product operation result based on a plurality of reference data stored in the server device and a homomorphic ciphertext if the homomorphic ciphertext generated using a coefficient encoding method is received from an external device; obtaining a personal information processing result corresponding to the homomorphic ciphertext based on the inner product operation result; and transmitting the obtained data to the external device.

The obtaining of the inner product operation result may include obtaining target data having a length corresponding to that of the homomorphic ciphertext by combining the plurality of reference data, performing a multiplication operation between the homomorphic ciphertext and the target data, and obtaining the inner product operation result from a multiplication operation result by using a module learning with errors (MLWE) extraction method.

The homomorphic ciphertext received from the external device may be a vector ciphertext in which messages are densely packed into a former half of the homomorphic ciphertext.

The obtaining of the inner product operation result may include generating the plurality of homomorphic ciphertexts by performing a plurality of automorphism transformations on the homomorphic ciphertext if the homomorphic ciphertext generated using the coefficient encoding method is received from the external device, and obtaining the inner product operation result by respectively multiplying a plurality of target data, which are obtained by combining data at corresponding positions in the plurality of reference data, by the plurality of homomorphic ciphertexts, and then summing a plurality of multiplication results.

The homomorphic ciphertext received from the external device may be a vector ciphertext in which messages are packed to be distributed at each predetermined distance.

The homomorphic ciphertext may be a homomorphic ciphertext for hash data that is generated using the coefficient encoding method, and the personal information processing result may include at least one of private information retrieval (PIR) result data in the form of a homomorphic ciphertext including data matching the hash data in the plurality of reference data or private membership test (PMT) result data in the form of a homomorphic ciphertext indicating whether the data matching the hash data is included in the plurality of reference data.

The obtaining of the personal information processing result based on the inner product operation result may include transforming the inner product operation result into a homomorphic ciphertext including 0 or 1 by substituting the inner product operation result into an approximation polynomial for approximating data to 0 in a section where a probability that the data included in an inner product operation result value is not 1 is higher than a predetermined threshold probability, obtaining the PIR result data by multiplying the transformed homomorphic ciphertext by each of the plurality of reference data, and obtaining the PMT result data by summing respective elements of the transformed homomorphic ciphertext.

According to an embodiment of the present disclosure, provided is a non-transitory readable recording medium storing a program for performing the data processing method described above.

According to the various embodiments of the present disclosure as described above, various services may be provided while maintaining security for information provided by the user. Accordingly, the user convenience may be greatly increased.

### BRIEF DESCRIPTION OF DRAWINGS

FIG. 1 is a diagram for describing operations of a server device and a terminal device according to at least one embodiment of the present disclosure;

FIG. 2 is a diagram for describing a configuration of the terminal device according to at least one embodiment of the present disclosure;

FIG. 3 is a block diagram showing a configuration of the server device according to at least one embodiment of the present disclosure;

FIGS. 4 to 8 are diagrams for describing an inner product operation method according to various embodiments of the present disclosure;

FIG. 9 is a flowchart for describing a data processing method according to various embodiments of the present disclosure;

FIGS. 10 and 11 are flowcharts for describing an inner product operation method according to various embodiments of the present disclosure; and,

FIG. 12 is a diagram for describing another example of an algorithm for performing an automorphism transformation.

### MODE FOR THE INVENTION

Encryption/decryption may be applied as necessary to a process of transmitting information (or data) that is performed in the present disclosure, and an expression describing the process of transmitting the information (or data) in the present disclosure and the claims should be interpreted as including all cases of the encryption/decryption even if not separately mentioned.

In the present disclosure, an expression such as “transmission (transfer) from A to B” or “reception from A to B” may include transmission (transfer) or reception while having another medium included in the middle, and may not necessarily express only the direct transmission (transfer) or reception from A to B.

In describing the present disclosure, a sequence of each step should be understood as non-restrictive unless a preceding step in the sequence of each step needs to logically and temporally precede a subsequent step. That is, except for the above exceptional case, the essence of the present disclosure is not affected even if a process described as the subsequent step is performed before a process described as the preceding step, and the scope of the present disclosure should also be defined regardless of the sequences of the steps. In addition, in this specification, “A or B” may be defined to indicate not only selectively indicating either A or B, but also including both A and B.

In addition, a term “including” in the present disclosure may encompass a concept of further including other components in addition to components listed as being included.

The present disclosure only describes essential components necessary for describing the present disclosure, and does not mention components unrelated to the essence of the present disclosure. In addition, it should not be interpreted as an exclusive concept that the present disclosure includes only the mentioned components, and should be interpreted as a non-exclusive concept that the present disclosure may include other components as well.

In addition, in the present disclosure, a “value” may be defined as a concept that includes not only a scalar value but also a vector or a polynomial form.

Mathematical operations and calculations in each step of the present disclosure described below may be implemented as computer operations by a known coding method and/or coding designed to be appropriate for the present disclosure to perform the corresponding operations or calculations.

Specific mathematical expressions described below are illustratively provided among possible alternatives, and the scope of the present disclosure should not be construed as being limited to the expressions mentioned in the present disclosure.

For convenience of description, the present disclosure defines the following notations.
a←D: Select an element a based on distribution D.
s1, s2 ∈R: Each of s1 and s2 is an element belonging to a set R.
mod (q): reduction operation modulo the integer q.
[·]: round a value to a nearest integer.

Hereinafter, various embodiments of the present disclosure are described in detail with reference to the accompanying drawings.

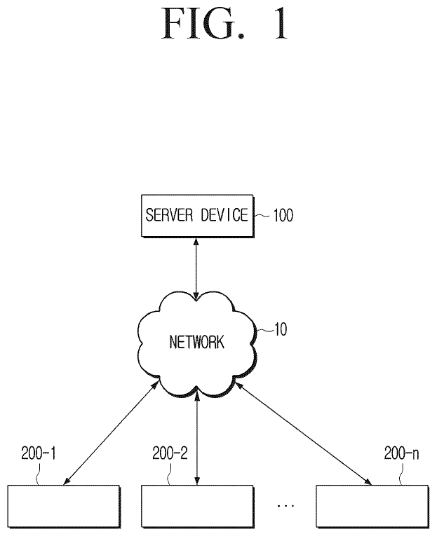

FIG. 1 is a diagram for describing an operation of an electronic device according to at least one embodiment of the present disclosure. Referring to FIG. 1, a server device 100 may communicate with a plurality of terminal devices 200-1 to 200-n via a network 10.

The network 10 may be implemented as any of various forms of wired/wireless communication networks, a broadcast communication network, an optical communication network, a cloud communication network or the like. FIG. 1 shows that each of the terminal devices 200-1 to 200-n is connected to the server device 100 via the network 10, is not limited thereto, and each terminal device may be directly connected to the server device 100 without a separate medium, wireless fidelity (Wi-Fi), Bluetooth, or near field communication (NFC).

As shown in FIG. 1, the server device 100 is a device for receiving and processing data from each of the terminal devices 200-1 to 200-n.

The server device 100 may be implemented as a web server or a cloud server.

The terminal devices 200-1 to 200-n may be various electronic devices used by various users. In detail, the terminal devices 200-1 to 200-n may be implemented in various forms such as personal computers (PCs), laptop PCs, mobile phones, tablet PCs, kiosks, televisions (TVs), home servers, other electronic devices equipped with internet of things (IoT) functions, or game players. In FIG. 1, the server device 100 and the terminal devices 200-1 to 200-n are shown separately. However, the server device 100 and the terminal devices 200-1 to 200-n may be collectively referred to as the electronic devices. Alternatively, the remaining terminal devices 200-1 to 200-n based on the server device 100 may be referred to as external devices.

A user may access the server device 100 by using the terminal device (hereinafter referred to as the terminal device 200) carried by the user and then transmit arbitrary data to the server device 100. According to the various embodiments of the present disclosure, the terminal device 200 may transmit a homomorphic ciphertext that is obtained by homomorphically encrypting the data. Homomorphic encryption may be performed based on various schemes. A specific homomorphic encryption scheme is described again in detail in a section provided below.

If the homomorphic ciphertext is received, the server device 100 may transmit an operation result corresponding to the homomorphic ciphertext based on the homomorphic ciphertext and a plurality of pre-stored reference data. The operation may be performed in a homomorphically encrypted state, and the operation result may thus also be transmitted in the homomorphically encrypted state. Therefore, security may be maintained even if the data is leaked during a process of transmitting the data to the server device 100, performing the operation on the data within the server device 100, or managing the data because the data is in the homomorphic ciphertext state that a third party is unable to access.

The server device 100 may perform various types of operations. According to at least one embodiment of the present disclosure, the server device 100 may transmit a privacy-preserving response for protecting personal information. The privacy-preserving response may include at least one of private information retrieval (PIR) result data, private set intersection (PSI) result data, or private membership test (PMT) result data.

For example, each of the users of the plurality of terminal devices 200-1 to 200-n may homomorphically encrypt various personal information, such as a user face photo, user name, and date of birth, by using the user terminal device and then transmit the encrypted information to the server device 100.

The server device 100 may perform an inner product operation based on the homomorphic ciphertext to obtain the privacy-preserving response to the received homomorphic ciphertext. The server device 200 may obtain an inner product operation result based on the plurality of pre-stored reference data and the received homomorphic ciphertext, and obtain at least one of the private information retrieval (PIR) result data, the private set intersection (PSI) result data, or the private membership test (PMT) result data based on the inner product operation result. In detail, the PIR result data includes reference data retrieved by the user among the plurality of reference data, the PMT includes data indicating whether an item retrieved by the user is included among the plurality of reference data, and the PSI includes data corresponding to an intersection between the plurality of reference data and data retrieved by the user. The personal information may be protected because each result data is provided in a state where the server device 100 is unable to access what content the user views or what result data is transmitted to the user.

The inner product operation for the homomorphic ciphertext may be essentially used to obtain the privacy-preserving response as described above. However, conventionally, the inner product operation for the homomorphic ciphertext may require a lot of resources, which slows down an operation speed and increase an operation burden. According to the various embodiments of the present disclosure, efficiency of the inner product operation may be greatly improved, thereby increasing the operation speed and greatly reducing the operation burden.

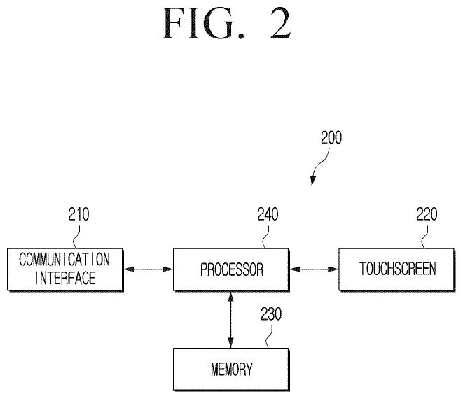

FIG. 2 is a block diagram showing a configuration of the terminal device 200 according to at least one embodiment of the present disclosure.

Referring to FIG. 2, the terminal device 200 may include a communication interface 210, a touchscreen 220, a memory 230, and a processor 240.

The communication interface 210 is a component for performing communication with various external devices including the server device 100. The communication interface 210 may transmit and receive various signals and data to and from the external device by using various wired and wireless communication methods such as wired/wireless local area network (LAN), wide area network (WAN), Ethernet, Institute of Electrical and Electronics Engineers 1394 (IEEE 1394), Bluetooth, access point (AP)-based Wi-Fi (or wireless LAN network), Zigbee, high-definition multimedia interface (HDMI), universal serial bus (USB), mobile high-definition link (MHL), audio engineering society/European broadcasting union (AES/EBU), optical communication, or coaxial cable. The communication interface 210 may also be referred to as a communication unit or a communication module.

The touchscreen 220 is a component for receiving various user inputs by touch or displaying various screens. If the terminal device 200 is implemented as a smartphone or a tablet PC, the touchscreen 220 may be used as a primary input/output device. However, the touchscreen 220 may be omitted depending on a type of the terminal device 200. For example, if the terminal device 200 is a PC, the terminal device 200 may be used while connected to an external monitor, an input device, or the like instead of the touchscreen 220.

The memory 230 is a component for storing various programs, data, instructions, or the like required for operating the terminal device 200. The memory 230 may be implemented as at least one of various memories such as a random access memory (RAM, e.g., a dynamic RAM (DRAM)), a static RAM (SRAM), a synchronous dynamic RAM (SDRAM), a one time programmable ROM (OTPROM), a programmable ROM (PROM), an erasable and programmable ROM (EPROM), an electrically erasable and programmable ROM (EEPROM), a mask ROM, a flash ROM, a flash memory, a hard drive, or a solid state drive (SSD).

The processor 240 is a component for controlling overall operations of the terminal device 200. The processor 240 may perform various operations based on instructions, programs, data, or the like stored in the memory 230.

The processor 240 may be implemented as a digital signal processor (DSP) or a microprocessor for processing a digital signal, is not limited thereto, and may include at least one of a central processing unit (CPU), a micro controller unit (MCU), a micro processing unit (MPU), a controller, an application processor (AP), a communication processor (CP), an advanced RISC (Reduced Instruction Set Computer) machine (ARM) processor, or an artificial intelligence (AI) processor, or may be defined by a relevant term. In addition, the processor 240 may be implemented as a system-on-chip (SoC) or a large scale integration (LSI) that has a processing algorithm embedded therein, or may be implemented as a field programmable gate array (FPGA). The processor 240 may perform various functions by executing computer executable instructions stored in the memory 230.

In detail, if the processor 240 receives the personal information of the user through various input means such as the touchscreen 220, a camera, and a microphone, the processor 240 may obtain the homomorphic ciphertext by performing the homomorphic encryption on the personal information. The personal information may include various types of information such as image data such as a photo, or text data such as the name, a phone number, an address, or an email address.

The homomorphic ciphertext may be generated by encrypting a plaintext message by using a public key. The homomorphic ciphertext may be generated in a form that satisfies the following property if decrypted using a secret key.

$$Dec ( ct , sk ) = 〈 ct , sk 〉 = M + e ( mod q ) . \qquad 〈 Equation 1 〉$$

Here, < and > indicate inner product operation (or usual inner product), ct indicates the ciphertext, sk indicates the secret key, M indicates the plaintext message, e indicates an encryption error value, and mod q indicates a ciphertext modulus. q needs to be selected to be greater than a result value M multiplied by a scaling factor Δ to the message. If an absolute value of the error value e is sufficiently smaller than M, a decrypted value M+e of the ciphertext may be a value that may replace an original message by the same precision in a significant figure operation. Among decrypted data, the error may be disposed on the least significant bit (LSB), and M may be disposed on the next least significant bit.

The public key and the secret key are required to perform the homomorphic encryption. The processor 240 may generate and use the public key required to perform the encryption on its own, or may receive and use the public key from the external device. For example, another terminal device that performs the decryption may generate the public key and the secret key, respectively, and then distribute the public key among the generated keys to other devices.

A method for generating the public key or the secret key may be implemented in various ways. For example, the processor 240 may generate the public key by using a ring learning with errors (RLWE) scheme. In detail, the processor 240 may first set various parameters and rings and store the same in the memory 230. An example of the parameter may include a length of a plaintext message bit, a size of the public key, a size of the secret key, or the like.

The ring may be expressed by the following equation.

$$R = {ℤ}_{q} [ x ] / ( f ( x ) ) . \qquad 〈 Equation 2 〉$$

Here, R indicates the ring, Z_{q} indicates a coefficient, and f(x) indicates a degree N polynomial.

The ring indicates a set of polynomials having predetermined coefficients, and indicates the set in which addition and multiplication are defined between elements and which is closed under the addition and multiplication.

As an example, the ring R indicates a set of the N-th polynomials having the coefficient Z_{q}. In detail, if n is Φ(N), an N-th cyclotomic polynomial may be used. (f(x)) indicates ideal of Z_{q}[x] generated by f(x). The Euler totient function Φ(N) indicates the number of natural numbers that are coprime to N and smaller than N. If ΦN(x) is defined as the n-th cyclotomic polynomial, the ring may also be expressed by Equation 3 as follows.

$$R = {ℤ}_{q} [ x ] / ( {Φ}_{N} ( x ) ) . \qquad 〈 Equation 3 〉$$

The ring R in Equation 3 described above may have complex numbers in a plaintext space. Meanwhile, only the set of rings described above whose plaintext space is real numbers may be used to improve the operation speed for the homomorphic ciphertext.

If the ring is set, the processor 240 may calculate the secret key sk from the ring.

The secret key sk may be expressed as follows.

$$sk ← ( 1 , s ( x ) ) , s ( x ) ∈ R \qquad 〈 Equation 4 〉$$

Here, s(x) indicates a random polynomial generated using a small coefficient.

In addition, the processor 240 may calculate a first random polynomial a(x) from the ring. The first random polynomial may be expressed as follows.

$$a ( x ) ← R . \qquad 〈 Equation 5 〉$$

In addition, the processor 240 may calculate an error. In detail, the processor 240 may extract the error from a discrete Gaussian distribution or a distribution having a statistical distance close thereto. This error may be expressed as follows.

$$e ( x ) ← {𝒟}_{α q}^{n} . \qquad 〈 Equation 6 〉$$

If even the error is calculated, the processor 240 may calculate a second random polynomial by performing the modular operations on the error in the first random polynomial and the secret key. The second random polynomial may be expressed as follows.

$$b ( x ) = - a ( x ) s ( x ) + e ( x ) ( mod q ) . \qquad 〈 Equation 7 〉$$

Finally, a public key pk may be set to include the first random polynomial and the second random polynomial as follows.

$$pk = ( b ( x ) , a ( x ) ) . \qquad 〈 Equation 8 〉$$

The key generation method described above is only an example, is not necessarily limited thereto, and the processor 240 may also generate the public key and the secret key in other ways.

The processor 240 may store the generated public key and secret key in the memory 230. These keys are used for the homomorphic encryption, and thus be collectively referred to as homomorphic encryption keys. In addition to the public key and the secret key described above, the homomorphic encryption key may also include an operation key used in performing an operation in the homomorphic ciphertext state. The operation key may include a rotation key, a multiplication key, an addition key, or the like. In the various embodiments of the present disclosures, a Cheon-Kim-Kim-Song (CKKS) scheme is described as a standard scheme among homomorphic encryption schemes. However, the homomorphic encryption scheme is not limited thereto, and various schemes such as a Brakerski-Gentry-Vaikuntanathan (BGV) scheme and a Brakerski-Fan-Vercauteren (BFV) scheme may be used. The processor 240 may process data requested from an application device into the homomorphic ciphertext state, and then homomorphically decrypt the result and transmit the same to the application device.

The homomorphic decryption refers to a task of transforming the homomorphic ciphertext into a plaintext. Assuming that the CKKS scheme is used, the processor 240 may apply the secret key sk to a homomorphic ciphertext ct=(c0, c1) to generate a message polynomial D(c, sk)=c0+c1sk, and then scale the same by applying the scaling factor Δ to restore an approximate message M′ for the original message M. The processor 240 may then perform an inverse Fourier transform to restore an original vector message.

The processor 240 of the terminal device 200 may transmit, to the server device 100, the homomorphic ciphertext, which is obtained by homomorphically encrypting various personal information, and receive a result of processing the personal information from the server device 100 through the communication interface 210. The personal information processing result may include the private information retrieval (PIR) result data, the private membership test (PMT) result data, the private set intersection (PSI) result data, or at least one of these result data.

The PIR result data refers to a homomorphic ciphertext including data matching the homomorphic ciphertext transmitted from the terminal device 100. The PMT result data refers to a homomorphic ciphertext indicating whether the data matching the homomorphic ciphertext transmitted from the terminal device 100 belongs to data stored in the server device 100, that is, the presence or absence of the data. The PSI result data refers to a homomorphic ciphertext including data common between the data matching the homomorphic ciphertext transmitted from the terminal device 100 and the data stored in the server device 200.

For example, if the user captures the face photo by using the terminal device 200 and then transmits the homomorphic ciphertext for the face photo to the server device 100, the server device 100 may transmit the homomorphic ciphertext including various information related to the face photo (for example, the name, the address, or the phone number), transmit the homomorphic ciphertext indicating whether the face photo is included in the stored data, or transmit the homomorphic ciphertext including a face photo matching the received face photo among stored photos.

According to at least one embodiment of the present disclosure, the processor 240 may perform the homomorphic encryption by using a coefficient encoding method and transmit the homomorphic ciphertext. The coefficient encoding method refers to a method of encrypting input data such as integers or bit strings by configuring the input data as a polynomial having coefficients.

For example, if coefficient encoding is performed on a vector z belonging to a ring RN, an encoding result Ecd(z) may be expressed as follows.

$$\text{?} Ecd ( \vec{z} ) := {\sum }_{i = 0}^{N - 1} ⌊ Δ \cdot z [ i ] ⌉ ∈ ℛ \qquad 〈 Equation 9 〉$$

$$\text{?} \text{indicates text missing or illegible when filed}$$

Here, Δ represents the scaling factor.

The homomorphic ciphertext ct that is obtained by encoding plaintext data m by using the coefficient may be expressed as follows.

$$ct = ( b , a ) = ( - as + m + e , a ) ∈ {ℛ}_{q}^{2} . \qquad 〈 Equation 10 〉$$

If the homomorphic ciphertext that is homomorphically encrypted by using the coefficient encoding method is received, the server device 100 may perform the inner product operation on the homomorphic ciphertext to obtain the various personal information processing results as described above.

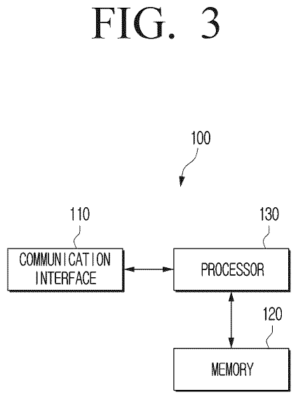

FIG. 3 is a block diagram showing a configuration of the server device according to the various embodiments of the present disclosure. Referring to FIG. 3, the server device 100 may include a communication interface 110, a memory 120, and a processor 130. Specific examples for each of the communication interface 110, the memory 120, and the processor 130 are the same as those described with reference to FIG. 2 above, and redundant descriptions thereof are thus omitted.

The server device 100 may be implemented as a web server, cloud server, or the like to provide various services. For example, the server device 100 may be used in various fields that emphasize the security, such as a medical management server that stores information on various patients, and a management server, a financial institution server, an access control server, or the like that stores user-specific authorization information.

The communication interface 110 of the server device 100 may communicate with the various external devices as shown in FIG. 1. For example, the communication interface 110 may also communicate with the terminal device 200 shown in FIG. 2.

The memory 120 may store various programs, instructions, and data for operating the server device 100. For example, the memory 120 may store the plurality of reference data. The reference data may include various data depending on the type of the server device 100 or the type of service provided by the server device 100. In detail, the reference data may include the various data such as the face photo, a pupil image, a fingerprint image, the name, the address, the phone number, an identification (ID), a password, or a user authorization. The reference data may also be stored in the homomorphically encrypted state as described above, or in the form of plaintext data.

The processor 130 may obtain the inner product operation result based on the homomorphic ciphertext and the plurality of reference data stored in the memory 120 if the homomorphic ciphertext generated using the coefficient encoding method is received through the communication interface 110. The processor 130 may obtain the personal information processing result based on the inner product operation result and then transmit the result to the external device through the communication interface 100. The external device may be the terminal device 200 that generates the homomorphic ciphertext or may be a device other than the terminal device 200. The personal information processing result may include at least one of the PIR result data, the PMT result data, or the PSI result data.

The processor 130 may perform the inner product operation on the homomorphic ciphertext in various ways according to the various embodiments of the present disclosure.

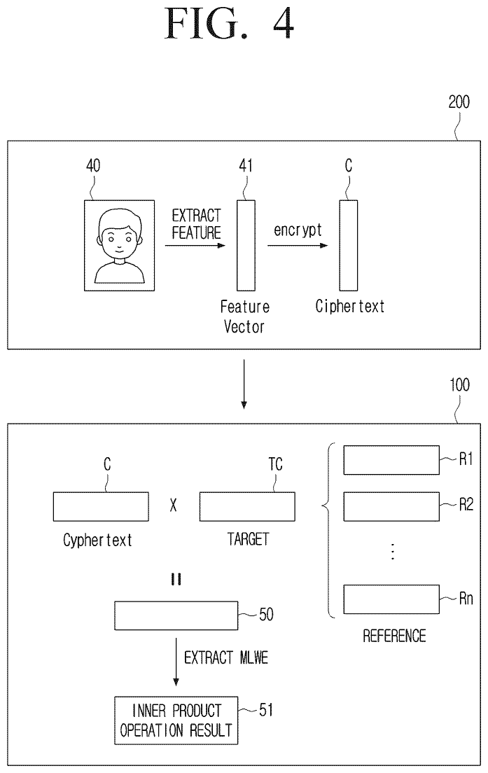

FIG. 4 is a diagram for describing the inner product operation method of the server device according to at least one embodiment of the present disclosure.

According to at least one embodiment of the present disclosure, the server device 100 may use a ring packing scheme in a fully homomorphic encryption environment.

As shown in FIG. 4, the terminal device 200 may extract a feature vector 410 from input data 40 and then homomorphically encrypt the extracted feature vector to obtain a homomorphic ciphertext C. The homomorphic ciphertext C obtained by the terminal device 200 may be a vector ciphertext in which the input data are densely packed into a former half of the homomorphic ciphertext C. The terminal device 200 may transmit the obtained homomorphic ciphertext C to the server device 100.

The processor 130 of the server device 100 may obtain target data TC having a length corresponding to that of the homomorphic ciphertext by combining an appropriate number of reference data among the plurality of reference data R1 to Rn pre-stored in the memory 120. The processor 130 may perform a multiplication operation for multiplying the received homomorphic ciphertext C by the obtained target data TC, and then obtain an inner product operation result 51 from a multiplication operation result 50 by using a module learning with errors (MLWE) extraction scheme.

The MLWE scheme refers to a homomorphic encryption method that is an intermediate stage between learning with errors (LWE) and RLWE schemes.

The learning with errors (LWE) scheme refers to a scheme for performing the homomorphic encryption by including an error, and requires a lot of calculations, and results in a homomorphic ciphertext size becoming much larger than that of the message.

The ring learning with errors (RLWE) scheme refers to a scheme that extends the LWE scheme to a polynomial ring, and has an improved effect in terms of computational efficiency compared to the LWE scheme.

The module learning with errors (MLWE) scheme refers to a homomorphic encryption method that uses a polynomial operation in the form of a vector, and generates the homomorphic ciphertext expressed in the form of a polynomial vector.

The processor 240 may perform ring packing and extraction operations by using the MLWE scheme.

The ring packing operation refers to an operation that packs a plurality of MLWE ciphertexts into one RLWE ciphertext, and the extraction operation refers to an operation that extracts an MLWE ciphertext from one RLWE ciphertext.

If a ring dimension (degree) n is expanded from the ring defined in Equation 3 described above, the ring may be expressed as R_{q,n}=Z_{q}[X]/(Xⁿ*1).

The processor 130 may extract an MLWE ciphertext having a specific degree d and a rank k, i.e., MLWE^{k}_{d}, from the multiplication operation result 50. Elements included in MLWE^{k}_{d} are R_{q,d}×R^{k}_{q,d}. Here, a case where d=1 corresponds to LWE, and a case where k=1 corresponds to RLWE.

For example, the processor 130 may perform MLWE-to-RLWE ring packing without intermediate stages.

If N=dk, the number of MLWE ciphertexts that serve as the reference data is k, the degree is d, the rank is k, and an MLWE secret key is s, an i-th ciphertext among the plurality of MLWE ciphertexts may thus be expressed as follows.

$${ct}_{i} = ( {b}_{i} , ( {a}_{i 0} . {a}_{i 1} , … , {a}_{i ( k - 1 )} ) ) ∈ {ℛ}_{q , d} \times {ℛ}_{q , d}^{k} . \qquad 〈 Equation 11 〉$$

$$Here , i ∈ ( 0 , 1 , … , k - 1 ) .$$

A decryption equation for each ciphertext may be expressed as follows:

$${ct}_{i} \cdot ( 1 , s ) = {b}_{i} + {\sum }_{j = 0}^{k - 1} {a}_{ij} {s}_{j} . \qquad 〈 Equation 12 〉$$

If t is defined as i(p(X))=p(X^{k})∈ [symbol] _{q,d}, a result of summing the decryption equations for each ciphertext may be expressed as follows.

$$( {\sum }_{j = 0}^{k - 1} {X}^{i} \cdot i ( {ct}_{i} ) ) \cdot ( 1 , i ( s ) ) = {\sum }_{i = 0}^{k - 1} {X}^{i} \cdot i ( {b}_{i} ) + {\sum }_{j = 0}^{k - 1} ( {\sum }_{i = 0}^{k - 1} {X}^{i} \cdot i ( {a}_{ij} ) ) \cdot i ( {s}_{j} ) = B + {\sum }_{j = 0}^{k - 1} {A}_{j} \cdot i ( {s}_{j} ) ∈ {ℛ}_{q , N .} \qquad 〈 Equation 13 〉$$

As a result, a plurality of MLWE ciphertexts ctₒ to ctₖ₋₁ may be packed into a RLWE ciphertext having a plurality of secret keys. That is, the processor 130 may transform the k reference data stored in the memory, i.e., the plurality of reference data, into one target data, i.e., a target ciphertext. Each secret key for the plurality of reference data may be a unified RLWE secret key by performing key switching.

An MLWE extraction operation may be performed relatively simply. For example, if the multiplication operation result is an RLWE ciphertext ct=(b,a)∈R²_{q,N} having a secret key S∈R_{q,N}, b, a, and the secret key s may be expressed as follows.

$$b = {\sum }_{i = 0}^{k - 1} {X}^{i} \cdot i ( {b}_{i} ) , a = {\sum }_{i = 0}^{k - 1} {X}^{i} \cdot i ( {a}_{i} ) , s = {\sum }_{i = 0}^{k - 1} {X}^{i} \cdot i ( {s}_{i} ) . \qquad 〈 Equation 14 〉$$

In this case, the decryption equation may be expressed as follows.

$${\sum }_{i = 0}^{k - 1} {X}^{i} \cdot ( i ( {b}_{i} ) + {\sum }_{j = 0}^{i} i ( {a}_{j} ) \cdot i ( {s}_{i - j} ) - {\sum }_{j = i + 1}^{k - 1} i ( {a}_{j} ) \cdot i ( {s}_{i + k - j} ) ) = {\sum }_{i = 0}^{k - 1} {X}^{i} \cdot i ( {b}_{i} + {\sum }_{j = 0}^{i} {a}_{j} \cdot {s}_{i - j} - {\sum }_{j = i + 1}^{k - 1} {a}_{j} \cdot {s}_{i + k - j} ) = {\sum }_{i = 0}^{k - 1} {X}^{i} \cdot i ( {b}_{i} + ( {a}_{i} , {a}_{i - 1} , … , {a}_{i - k + 1} ) \cdot ( {s}_{0} , {s}_{1} , … , {s}_{k - 1} ) ) . \qquad 〈 Equation 15 〉$$

In addition to the MLWE extraction operation described above, the processor 130 may perform the MLWE extraction operation in various ways. As another example, the processor 130 may perform the ring packing operation, the module packing operation, or the MLWE operation in a manner disclosed in Korean Patent Application No. 10-2023-183562. A redundant description thereof is omitted.

The processor 130 may perform the MLWE extraction operation described above on the multiplication operation result 50 between the target data and the received homomorphic ciphertext, thereby obtaining the inner product operation result 51 between the received homomorphic ciphertext and the target data.

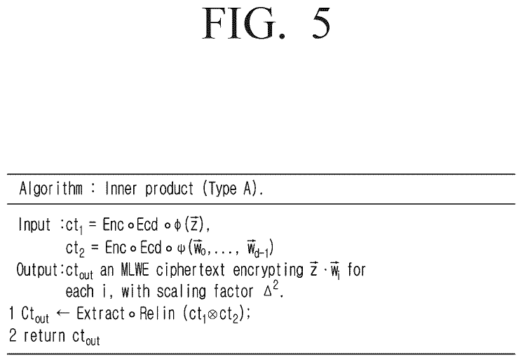

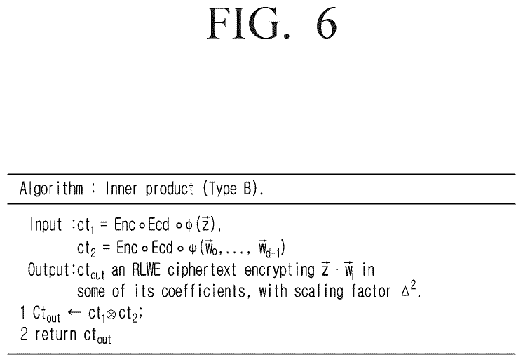

FIGS. 5 and 6 are diagrams for describing various examples of algorithms for performing the inner product operation of the server device according to at least one embodiment of the present disclosure.

FIG. 5 shows algorithm A, which is one of algorithms for performing the inner product operation on two homomorphic ciphertexts ct1 and ct2. As described above, the processor 130 may obtain the inner product operation result by performing the multiplication and the MLWE extraction operation on the homomorphic ciphertext of the coefficient encoded CKKS scheme.

In FIGS. 5 and 6, a function φ: [symbol] ^{k}→ [symbol] ^{N} is defined as follows.

$$\text{?} φ ( \vec{z} ) = ( z [ 0 ] , 0 , … , 0 , - z [ k - 1 ] , - z [ k - 2 ] , … , - z [ 1 ] ) . \qquad 〈 Equation 16 〉$$

$$\text{?} \text{indicates text missing or illegible when filed}$$

A function ψ:( [symbol] ^{k})^{d}→ [symbol] ^{N} is defined by the following concatenation operation, which concatenates each vector into one longer vector.

$$\text{?} ( {\vec{w}}_{0} , {\vec{w}}_{1} , … , {\vec{w}}_{d} ) ↦ ( {\vec{w}}_{0} , {\vec{w}}_{1} , … , {\vec{w}}_{d} ) . \qquad 〈 Equation 17 〉$$

$$\text{?} \text{indicates text missing or illegible when filed}$$

An extraction function may be defined as an MLWE extraction as described in the aforementioned section.

In the algorithm shown in FIG. 5, ct1 refers to a ciphertext encoded and homomorphically encrypted using the vector z, and ct2 refers to a ciphertext encoded and encrypted using a plurality of vectors. That is, ct1 may be the homomorphic ciphertext received from the terminal device 200, and ct2 may be the target data described above. If each of the plurality of reference data is the plaintext data, ct2 may be a ciphertext encoded and encrypted by combining the plurality of stored reference data. Alternatively, if each of the plurality of reference data is the homomorphic ciphertext, ct2 may be a ciphertext obtained by combining at least some of the reference data. That is, ct2 may be the target data described above.

The processor 130 may multiply the ciphertexts ct1 by ct2 and then perform a relinearization operation thereon. The relinearization operation may be an operation for transforming a high-degree term in the homomorphic ciphertext, which are polynomials, into a low-degree ciphertext by using a switching key or a relinearization key. After performing the relinearization operation, the processor 130 may perform the MLWE extraction operation for extracting only a necessary MLWE portion. An extracted result ctout may be an inner product result value 51 between the received homomorphic ciphertext and the target data.

Hereinabove, the algorithm for obtaining the inner product operation result in a form of the MLWE ciphertext by using the MLWE extraction method is described, and is not necessarily limited thereto. That is, according to another embodiment of the present disclosure, the inner product operation result in a form of the RLWE ciphertext may also be obtained.

FIG. 6 is a diagram for describing the algorithm for obtaining the inner product operation result in a different way from FIG. 5. Referring to FIG. 6, the processor 130 may multiply the received homomorphic ciphertext by the target data and then output the operation result as it is without any separate extraction or transformation. The algorithm shown in FIG. 6 may be used in a case where the result is to be provided as the RLWE ciphertext. The algorithm shown in FIG. 6 may be used in a case of requiring an additional homomorphic operation, which may derive a complicated and large operation result value. The algorithm shown in FIG. 5 may be used in a case where a subsequent operation needs to be simple because the operation result value may be derived simply and concisely.

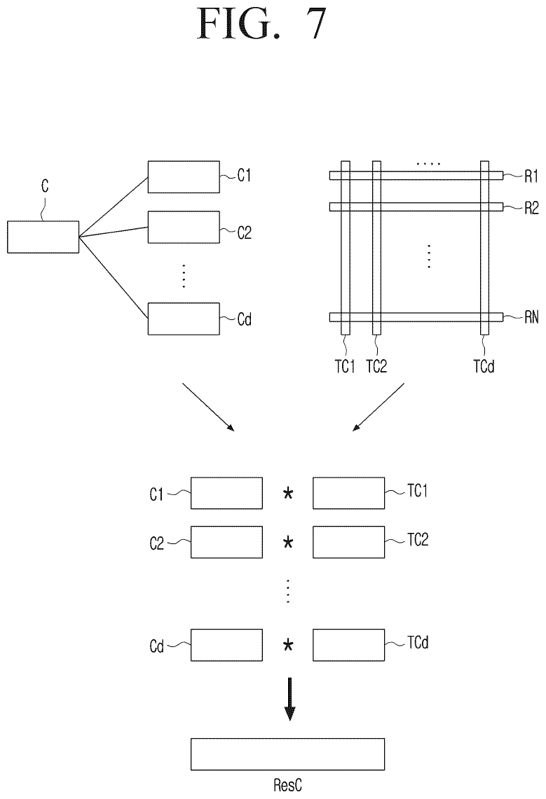

FIG. 7 is a diagram for describing another method for performing the inner product operation of the server device according to at least one embodiment of the present disclosure.

Referring to FIG. 7, the processor 130 may generate a plurality of homomorphic ciphertexts C1 to Cd by performing a plurality of automorphism transformations on the homomorphic ciphertext if the homomorphic ciphertext C generated using the coefficient encoding method is received from the terminal device 100 through the communication interface 210. The automorphism transformation refers to a task of changing the structure or form of the homomorphic ciphertext while preserving the information in the homomorphic ciphertext. The processor 130 may sequentially perform the plurality of automorphism transformations to obtain the plurality of homomorphic ciphertexts C1 to Cd.

The homomorphic ciphertext C may include a vector ciphertext in which messages to be transmitted are packed to be distributed at each predetermined distance. For example, if a degree of the homomorphic ciphertext C is N and a dimension of the vector to perform the inner product operation is d, the terminal device 200 may generate and transmit the homomorphic ciphertext C by arranging and encrypting respective values q_1 to q_d of the vector Q at an interval of N/d. The processor 130 of the server device 100 may perform a homomorphic trace on the homomorphic ciphertext C received from the terminal device 200 by using the automorphism to generate the plurality of homomorphic ciphertexts C1 to Cd, each of which includes one of values Q_1 to Q_d.

Separately, the processor 130 may generate a plurality of target data TC1 to TCd by combining data at corresponding positions in the plurality of reference data R1 to Rn stored in the memory 120. In detail, the processor 130 may generate the plurality of target data TC1 to TCd including values that transpose specific values of the reference data R1 to Rn in a form of the stored vector. The corresponding positions refer to data positioned in a predetermined sequence or position in the plurality of reference data, and are not necessarily limited thereto. The target data TC1 to TCd may be the homomorphic ciphertexts, are not necessarily limited thereto, and may be the plaintext data.

The processor 130 may obtain an inner product operation result ResC by performing the inner product operation between the plurality of homomorphic ciphertexts C1 to Cd generated using the plurality of automorphism transformations and the plurality of target data TC1 to TCd. The inner product operation result ResC may be a homomorphic ciphertext including N inner product values, such as TC1*C1+TC2*C2+ . . . +TCd*Cd.

If the number of reference data to be operated is more than N, the processor 130 may perform the inner product operation between the homomorphic ciphertexts C1 to Cd and TC{d+1} to TC{2d} to generate a ciphertext ResC2 including the N inner product values.

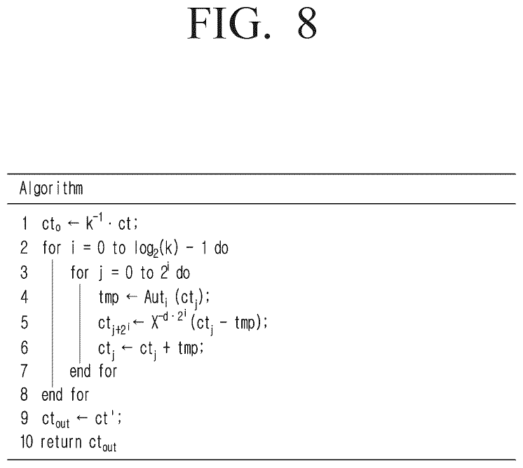

FIG. 8 shows an algorithm for describing an example of a method for performing the automorphism transformation. Referring to FIG. 8, the processor 130 may set the initial value ct₀ by multiplying the received homomorphic ciphertext ct by a constant k−1.

The processor 130 may repeatedly perform an inner loop for increasing j from 0 to 2ⁱ−1 at each stage and an outer loop for increasing i from 0 to log 2(k)−1, apply an automorphism Autᵢ(ctⱼ) multiple times, and then output the final result value ctout.

An automorphism Autᵢ may be expressed by the following equation.

$${Aut}_{i} = \{ \begin{matrix}X ↦ X \text{?} & 0 \leq i \leq {log}_{2} ( k ) - 2 \\ X ↦ {X}^{- 1} & i = {log}_{2} ( k )\end{matrix} \qquad 〈 Equation 18 〉$$

$$\text{?} \text{indicates text missing or illegible when filed}$$

The automorphism Autᵢ is a form of transforming a variable X of the homomorphic ciphertext to another power.

As shown in FIGS. 7 and 8, if the automorphism is used, all slots in the homomorphic ciphertext may be accumulated into one while rotating each component in the homomorphic ciphertext. Accordingly, the inner product result value in the encrypted state may be included in the final result value ctout.

According to the inner product operation method described with reference to FIGS. 7 and 8, the homomorphic trace may be performed only a single time regardless of the number of reference data, and the inner product operation may require a small cost compared to the homomorphic trace, thereby providing increased efficiency as the number of reference data increases. Therefore, the efficiency of the inner product operation on the homomorphic ciphertext may be greatly increased, and the operation speed may also be improved.

Hereinabove, the various embodiments of the present disclosure are described based on the CKKS scheme, are not limited thereto, and may be applied not only to CKKS but also to the RLWE-based homomorphic encryption scheme (e.g., BFV or BGV).

As described above, according to the various embodiments of the present disclosure, the inner product operation on the homomorphic ciphertext and the plurality of reference data may be efficiently performed. Therefore, various services utilizing the inner product operation may be provided more efficiently.

According to at least one embodiment of the present disclosure, the server device 100 may transmit the personal information processing result that is obtained by processing the personal information using the inner product operation result, to the terminal device 200 or other external device.

The personal information processing result may include the PIR result data, the PSI result data, or the PMT result data as described above.

To obtain the result data, the terminal device 200 may transmit the homomorphic ciphertext for hash data that is generated using the coefficient encoding method. If the various personal information, such as the user's face photo, the name, the address, the phone number, or the like is input through the touchscreen 220 or another input device, the processor 240 of the terminal device 200 may transform the personal information into the hash data by using a hash function, and then perform the homomorphic encryption on the transformed hash data. The homomorphic encryption method is described in detail in the aforementioned section, and a redundant description thereof is thus omitted. For example, the processor 240 may use a hash function such as SHA-256, is not necessarily limited thereto, and use MD5 or other SHA series functions.

If the homomorphic ciphertext for the hash data that is generated using the coefficient encoding method is received, the processor 130 of the server device 100 may obtain the inner product operation result between the received homomorphic ciphertext and the reference data stored in the memory 120. The inner product operation method is described in the various embodiments described above, and a redundant description thereof is thus omitted.

The processor 130 may transform the inner product operation result into a homomorphic ciphertext including 0 or 1 by substituting the inner product operation result into an approximation polynomial for approximating data to 0 in a section where a probability that the data included in an inner product operation result value is not 1 is higher than a predetermined threshold probability.

This approximation polynomial may also be referred to as a cleaning polynomial. In detail, the approximate polynomial refers to a polynomial that outputs 1 if data x included in the inner product operation result is 1, and outputs 0 if x∈[0.a] (where a<1).

For example, the approximate polynomial may be defined as follows.

$$P \text{?} ( x ) = T \text{?} ( \frac{2 X}{a} - 1 ) . \qquad 〈 Equation 19 〉$$

$$\text{?} \text{indicates text missing or illegible when filed}$$

Here, Tₙ indicates a Tchebychev polynomial defined as Tₙ(cos(u))=cos(nu), and n indicates an integer parameter.

The Tchebychev polynomial may be quickly computed as follows.

$${T}_{2 n} ( x ) = 2 {{T}_{n} ( x )}^{2} - 1.$$

$${T}_{2 n + 1} ( x ) = 2 {T}_{n} ( x ) {T}_{n + 1} ( x ) - x .$$

Using the approximation polynomial, even if x is not exactly 1, x may be considered as 1 and processed, thereby efficiently obtaining the personal information processing result. x=1 is not exactly established in the CKKS scheme, and the approximation polynomial may thus be used importantly to simultaneously secure the efficiency and accuracy.

In case that each of the received homomorphic ciphertext and the reference data is the hash data having the dimension k, if the two data are all the same, the inner product operation result is k, and if the two data are different, the inner product operation result is the sum of k independent uniform samples of {−1. 1}. Therefore, the inner product operation result is 0(√k) having a probability close to 1. The processor 130 may perform normalization by dividing the inner product operation result by k, and then substitute the same into the approximation polynomial.

The processor 130 may multiply the homomorphic ciphertext transformed using the approximation polynomial by the plurality of reference data stored in the memory 120, respectively. A result value obtained by multiplying the reference data by 0 among the respective elements of the transformed homomorphic ciphertext may be 0 regardless of a value of the reference data, and a result value obtained by multiplying the reference data by 1 among the respective elements of the homomorphic ciphertext may be the same as the stored reference data. Therefore, if all of the multiplication result values are summed, the final result value may be the same data as the value of the reference data that is obtained by multiplying the reference data by 1 among the respective elements of the homomorphic ciphertext. The operation is performed in the homomorphic ciphertext state, and the processor 130 may thus transmit the final result value to the terminal device 200 or the external device through the communication interface 110 without identifying what the inner product operation value, the multiplication result value, or the final result value is. That is, the final result value may be the PIR result data described above. The terminal device 200 may decrypt the PIR result data by using the secret key as described above, and obtain a retrieval result matching its personal information.

Alternatively, the processor 130 may obtain the PSI result data or the PMT result data by summing the respective elements of the transformed homomorphic ciphertext as described above. That is, each element of the transformed homomorphic ciphertext may be approximated to 0 or 1 by the approximation polynomial as described above. Accordingly, if there exists a 1 among the elements, an entire addition result may be 1. On the other hand, if the elements are all 0, the entire addition result may be 0.

The operation is performed in the homomorphic ciphertext state, and the processor 130 may thus transmit the entire addition result to the terminal device 200 or the external device without identifying whether the result value is 0 or 1. That is, the entire addition result may be the PMT result data indicating whether data matching the hash data is included in the plurality of reference data. The terminal device may decrypt the entire addition result by using the secret key, and determine that the data matching the hash data exists if the value is 1, and determine that no data exists if the value is 0. If this mechanism is used for the user authentication, the terminal device 200 may determine that the authentication fails if the personal information processing result of the server device 100 that corresponds to the personal information input by the user is 0, and may determine that the authentication is successful if the personal information processing result is 1.

Meanwhile, if PMT is seen as finding whether one query is included in a data set having N elements, PSI may be seen as finding whether M queries is included in the data set having N elements. Accordingly, the processor 130 may obtain the PSI result data by repeating a process for deriving a PMT result M times.

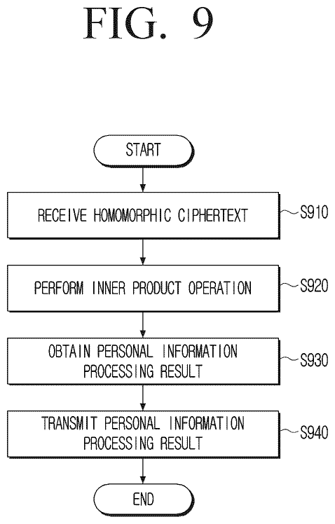

FIG. 9 is a flowchart for describing a data processing method of the server device according to at least one embodiment of the present disclosure.

Referring to FIG. 9, if the homomorphic ciphertext generated using the coefficient encoding method is received from the external device (S910), the plurality of reference data stored in the server device and the inner product operation result based on the homomorphic ciphertext may be obtained (S920).

The server device may obtain the personal information processing result based on the inner product operation result (S930). The personal information processing result may include at least one of the private information retrieval (PIR) result data, the private set intersection (PSI) result data, or the private membership test (PMT) result data.

An example of a protocol for obtaining the PIR result data may be summarized as follows.
1. The terminal device generates a fully homomorphic encryption (FHE) key pair (pk, sk): KeyGen.
2. The terminal device hashes an index i∈[L] of a database entry to be restored, computes h*←H(i), and then homomorphically encrypts the same to generate ct*.
3. The terminal device transmits the public key pk and the homomorphic ciphertext ct to the server device.
4. For each j∈[L], the server device computes hj←H(i), homomorphically compares a pair (h*, hj), and encrypts a comparison result to generate a homomorphic ciphertext ct*j.
5. The server device squares each ct*j multiple times to maintain a default plaintext as a value close to 0 if j≠i and as a value close to 1 if j=i.
6. The server device homomorphically computes <(ct*₁, . . . , ct*_{L}),DB>, generates a ciphertext that is obtained by encrypting a plaintext close to DB[i], and returns the same to the terminal device.
7. The terminal device decrypts the ciphertext and restores the plaintext close to DB[i].

This protocol may be performed between the terminal device 200 and the server device 100 described with reference to FIGS. 1 to 3.

If the reference data in the server device is stored in the homomorphically encrypted state as described in the various embodiments described above, stage 4 in the aforementioned protocol may be omitted. In addition, the various inner product operations described above may be performed in stages 5 and 6 in the aforementioned protocol.

The aforementioned protocol may also extend to a PSI protocol.

For example, assuming that the terminal device 200 has a private data set S1={x1, . . . , x1} and the server device 100 has a data set s2={y1, . . . , yn}, an example of the PSI protocol may be summarized as follows.
1. The terminal device generates the FHE key pair (pk, sk): KeyGen.
2. The terminal device computes hi←H(xi) for i∈l and then homomorphically encrypts the same to generate ctᵢ and transmits ctᵢ to the server device along with the public key pk.
3. The server device homomorphically compares each ctᵢ with H(yi) for j∈[n] and computes ct_{i,j} that is obtained by encrypting an inner product <H(xi), H(yi)>.
4. The server device squares and organizes each ct_{i,j}, and then sums the organized entire ct_{i,j} for the fixed i, and obtains a ciphertext c_{tres,i} that is obtained by encrypting a value close to 0 if xi does not belong to S2 and a value close to 1 if xi belongs to S2.
5. The server device returns ct_{res,1}, . . . and ct_{res,n} to the terminal device, and the terminal device may decrypt the same to restore an intersection between S1 and S2.

The inner product operation at stage 3 of the aforementioned protocol may be performed using the inner product operation method described in the various embodiments described above, and is not necessarily limited thereto.

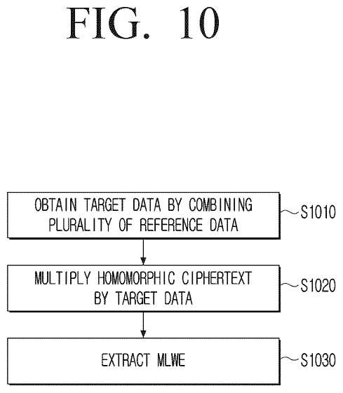

FIG. 10 is a flowchart for describing the inner product operation method of the server device according to at least one embodiment of the present disclosure.

Referring to FIG. 10, the server device may obtain the target data by combining the plurality of reference data (S1010), and obtain the multiplication result value by multiplying the homomorphic ciphertext received from the terminal device by the target data (S1020). The server device may perform the MLWE extraction operation for extracting the MLWE ciphertext from the obtained multiplication result value (S1030). The extracted result data may be the inner product operation result value. The inner product operation method shown in FIG. 10 is specifically described with reference to FIGS. 4 and 5, and a redundant description thereof is thus omitted.

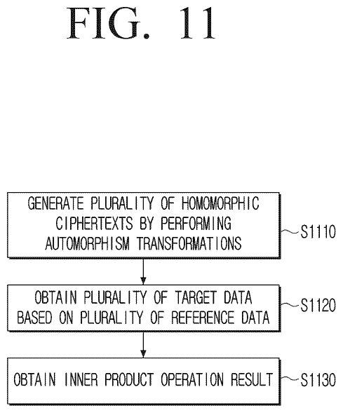

FIG. 11 is a flowchart for describing another example of the inner product operation method of the server device according to at least one embodiment of the present disclosure.

Referring to FIG. 11, the server device may generate the plurality of homomorphic ciphertexts by performing the plurality of automorphism transformations on the homomorphic ciphertext received from the terminal device (S1110).

The server device may obtain the plurality of target data by combining the data at the corresponding positions in the plurality of pre-stored reference data (S1120).

The step of performing the plurality of automorphism transformations and the step of obtaining the plurality of target data may not necessarily be performed sequentially, and may be performed in parallel or in an opposite order.

If the plurality of homomorphic ciphertexts and the plurality of target data are obtained, the server device may perform the multiplication operation between each homomorphic ciphertext and each target data and then sum the result values. The addition result may correspond to the inner product operation result for the homomorphic ciphertext and the reference data, and as a result, the server device may obtain the inner product operation result (S1130).

The algorithm for executing the inner product operation method described with reference to FIG. 11 is described with reference to FIG. 8. However, the automorphism described above may be performed based on various algorithms.

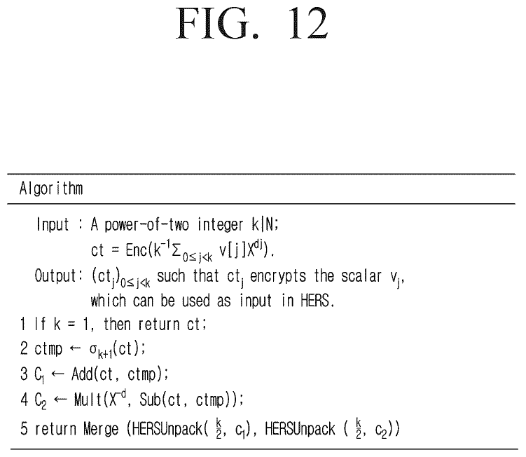

FIG. 12 shows another algorithm for performing the automorphism transformation.

Referring to FIG. 12, the homomorphic ciphertext ct received from the terminal device may be expressed as follows.

$$\text{?} ct = Enc ( {k}^{- 1} {\sum }_{0 \leq j \leq k} \text{?} [ j ] {X}^{dj} )$$

$$\text{?} \text{indicates text missing or illegible when filed}$$

A plurality of scalar values v[j] may be packed into the homomorphic ciphertext ct. The processor 130 of the server device 100 may unpack the received homomorphic ciphertext and separate each v[j] into the plurality of homomorphically encrypted homomorphic ciphertexts ctⱼ. Accordingly, (ctⱼ)_{0≤j<k} may be output.

In detail, referring to FIG. 12, the processor 130 may output k=1 as it is because this value is too small to be divided any further. The processor 130 may apply an automorphism σₖ₊₁ to the homomorphic ciphertext where k exceeds 1, and transform an exponent X in the homomorphic ciphertext to X^{k+1}.

The processor 130 may obtain c1 by summing the original homomorphic ciphertext ct and a transformed ciphertext ctmp. Accordingly, v[j]+v[j+k/2] may result in c1.

The processor 130 may calculate a difference between the original homomorphic ciphertext ct and the transformed ciphertext ctmp and multiply the difference by X^{-d}. Accordingly, v[j]−v[j+k/2] may result in c2.

The processor 130 may recursively divide the packed values into units of size k/2 and continuously process the unpacking. Finally, the processor 130 may sequentially merge an unpack result (HERSUnpack) for c1 and an unpack result for c2. A merging function refers to a function for alternating odd and even indices and merging a list L1 and a list L2.

Based on this algorithm, one homomorphic ciphertext ct may be transformed into the plurality of homomorphic ciphertexts.

The data processing method and the inner product operation method as described above may be performed by the server device shown in FIG. 3, are not necessarily limited thereto, and may be performed by another electronic device having various configurations added thereto or changed therefrom. Alternatively, these methods may be performed by the terminal device 200 shown in FIG. 2.

Hereinabove, the various embodiments of the present disclosure are described in detail for each embodiment. However, each embodiment is not necessarily implemented alone, and may also be implemented partially or entirely together with other embodiments.

Meanwhile, the methods according to at least some of the various embodiments of the present disclosure described above may be implemented in the form of an application capable of being installed on a conventional electronic device. In addition, the methods according to at least some of the various embodiments of the present disclosure described above may be implemented only by software upgrade or hardware upgrade of the conventional electronic device.

Meanwhile, according to an embodiment of the present disclosure, the various embodiments described above may be implemented in software including an instruction stored in a machine-readable storage medium (for example, a computer-readable storage medium). A machine may be an apparatus that invokes the stored instruction from the storage medium, may be operated based on the invoked instruction, and may include the electronic device (e.g., electronic device A) according to the disclosed embodiments. If the instruction is executed by the processor, the processor may perform a function corresponding to the instruction directly or by using another component under control of the processor. The instruction may include a code provided or executed by a compiler or an interpreter. The machine-readable storage medium may be provided in the form of a non-transitory storage medium. Here, the “non-transitory storage medium” may refer to a tangible device and only indicate that this storage medium does not include a signal (e.g., electromagnetic wave), and this term does not distinguish a case where data is stored semi-permanently in the storage medium and a case where data is temporarily stored in the storage medium from each other. For example, the “non-transitory storage medium” may include a buffer in which data is temporarily stored.

According to an embodiment, the methods according to the various embodiments disclosed in the present disclosure may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online (e.g., by download or upload) via an application store (e.g., PlayStore™) or directly between two user devices (e.g., smartphones). In case of the online distribution, at least a part of the computer program product (e.g., downloadable app) may be at least temporarily stored or temporarily provided in the machine-readable storage medium such as a server memory of a manufacturer, a server memory of an application store, or a relay server memory.

Although the embodiments of the present disclosure are shown and described as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

1. A server device comprising:
a communication interface configured to communicate with an external device;
a memory storing a plurality of reference data; and
a processor,
wherein the processor is configured to
obtain an inner product operation result based on the plurality of reference data and a homomorphic ciphertext if the homomorphic ciphertext generated using a coefficient encoding method is received from the external device through the communication interface, and
transmit at least one of private information retrieval (PIR) result data, private membership test (PMT) result data, or private set intersection (PSI) result data, obtained based on the inner product operation result, to the external device through the communication interface.

2. The device as claimed in claim 1, wherein the processor is configured to
obtain target data having a length corresponding to that of the homomorphic ciphertext by combining the plurality of reference data,
perform a multiplication operation between the homomorphic ciphertext and the target data, and
obtain the inner product operation result from a multiplication operation result by using a module learning with errors (MLWE) extraction method.

3. The device as claimed in claim 2, wherein the homomorphic ciphertext received from the external device is a vector ciphertext in which messages are densely packed into a former half of the homomorphic ciphertext.

4. The device as claimed in claim 1, wherein the processor is configured to
generate the plurality of homomorphic ciphertexts by performing a plurality of automorphism transformations on the homomorphic ciphertext if the homomorphic ciphertext generated using the coefficient encoding method is received from the external device through the communication interface, and
obtain the inner product operation result by respectively multiplying a plurality of target data, which are obtained by combining data at corresponding positions in the plurality of reference data, by the plurality of homomorphic ciphertexts, and then summing a plurality of multiplication results.

5. The device as claimed in claim 4, wherein the homomorphic ciphertext received from the external device is a vector ciphertext in which messages are packed to be distributed at each predetermined distance.

6. The device as claimed in claim 1, wherein the homomorphic ciphertext is a homomorphic ciphertext for hash data that is generated using the coefficient encoding method,
the PIR result data is a homomorphic ciphertext including data matching the hash data in the plurality of reference data, and
the PSI result data is a homomorphic ciphertext indicating whether the data matching the hash data is included in the plurality of reference data.

7. The device as claimed in claim 6, wherein the processor is configured to
transform the inner product operation result into a homomorphic ciphertext including 0 or 1 by substituting the inner product operation result into an approximation polynomial for approximating data to 0 in a section where a probability that the data included in an inner product operation result value is not 1 is higher than a predetermined threshold probability,
obtain the PIR result data by multiplying the transformed homomorphic ciphertext by each of the plurality of reference data, and
obtain the PSI result data by summing respective elements of the transformed homomorphic ciphertext.

8. A data processing method of a server device, the method comprising:
obtaining an inner product operation result based on a plurality of reference data stored in the server device and a homomorphic ciphertext if the homomorphic ciphertext generated using a coefficient encoding method is received from an external device;
obtaining a personal information processing result corresponding to the homomorphic ciphertext based on the inner product operation result; and
transmitting the obtained data to the external device.

9. The method as claimed in claim 8, wherein the obtaining of the inner product operation result includes
obtaining target data having a length corresponding to that of the homomorphic ciphertext by combining the plurality of reference data,
performing a multiplication operation between the homomorphic ciphertext and the target data, and
obtaining the inner product operation result from a multiplication operation result by using a module learning with errors (MLWE) extraction method.

10. The method as claimed in claim 9, wherein the homomorphic ciphertext received from the external device is a vector ciphertext in which messages are densely packed into a former half of the homomorphic ciphertext.

11. The method as claimed in claim 8, wherein the obtaining of the inner product operation result includes
generating the plurality of homomorphic ciphertexts by performing a plurality of automorphism transformations on the homomorphic ciphertext if the homomorphic ciphertext generated using the coefficient encoding method is received from the external device, and
obtaining the inner product operation result by respectively multiplying a plurality of target data, which are obtained by combining data at corresponding positions in the plurality of reference data, by the plurality of homomorphic ciphertexts, and then summing a plurality of multiplication results.

12. The method as claimed in claim 11, wherein the homomorphic ciphertext received from the external device is a vector ciphertext in which messages are packed to be distributed at each predetermined distance.

13. The method as claimed in claim 8, wherein the homomorphic ciphertext is a homomorphic ciphertext for hash data that is generated using the coefficient encoding method, and
the personal information processing result includes at least one of private information retrieval (PIR) result data in the form of a homomorphic ciphertext including data matching the hash data in the plurality of reference data or private membership test (PMT) result data in the form of a homomorphic ciphertext indicating whether the data matching the hash data is included in the plurality of reference data.

14. The method as claimed in claim 13, wherein the obtaining of the personal information processing result based on the inner product operation result includes
transforming the inner product operation result into a homomorphic ciphertext including 0 or 1 by substituting the inner product operation result into an approximation polynomial for approximating data to 0 in a section where a probability that the data included in an inner product operation result value is not 1 is higher than a predetermined threshold probability,
obtaining the PIR result data by multiplying the transformed homomorphic ciphertext by each of the plurality of reference data, and
obtaining the PMT result data by summing respective elements of the transformed homomorphic ciphertext.

15. A non-transitory readable recording medium storing a program for performing a data processing method, wherein the method includes
obtaining an inner product operation result based on a plurality of reference data stored in the server device and a homomorphic ciphertext if the homomorphic ciphertext generated using a coefficient encoding method is received from an external device,
obtaining at least one of private information retrieval (PIR) result data and private set intersection (PSI) result data based on the inner product operation result, and
transmitting the obtained data to the external device.
